(19) United States
(12) Patent Application Publication
(10) Pub. No.: US 2011/0016166 A1
(43) Pub. Date: Jan. 20, 2011

(54) Numeric Decision Device

(76) Inventor: Cheng-Chung Shih, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/607,064

(22) Filed: Oct. 28, 2009

(30) Foreign Application Priority Data
Jul. 15, 2009 (TW) 098123875

(51) Int. Cl. G06F 17/10

(52) U.S. Cl. 708/207; 708/202; 708/316

(57) ABSTRACT

A numeric decision device for determining a numeric of a specific order in a plurality of numerics includes a plurality of reception ends, a plurality of multiplexer modules each for outputting a numeric received by a reception end or a default value, a comparison module for comparing output signals of the plurality of multiplexer modules to generate a plurality of comparison results and for determining an extreme value, a decoding module for generating a plurality of decoding results according to the plurality of comparison result, a driving module for controlling the plurality of multiplexer modules, the comparison module and the decoding module to operate a default time corresponding to the specific order, and an output unit for outputting the extreme value after the comparison module operates for the default time to determine the numeric of the specific order.

### BACKGROUND OF THE INVENTION

1. Field of the Invention

The present invention is related to a numeric decision device, and more particularly, to a numeric decision device capable of determining any of a plurality of numerics with specific meaning of order.

2. Description of the Prior Art

A median filter is an electric device frequently employed in data processing, in order to determine a median in a set of sequential numerics. In the prior art, the median filter is implemented by tons of comparison and logic operations, and complexity thereof increases with the amount of the sequential numerics.

For example, please refer to FIG. 1, which is a schematic diagram of a median filter 10 of the prior art. The median filter 10 performs seven samples, i.e. can determine a median VL_med in numerics VL_1˜VL_7. The median filter 10 is mainly composed of a comparison module 100, a logic module 102 and a multiplexer module 104. The comparison module 100 includes 21 comparators CMP, each for comparing numerics received at “+” end and “−” end thereof. If the “+” numeric is greater than or equal to the “−” numeric, the comparator CMP outputs “1” (a square wave with high voltage level); else, outputs “0” (a square wave with low voltage level). The logic module 102 includes logic units LGC_2˜LGC_7 respectively corresponding to the numerics VL_2˜VL_7. Each of the logic units LGC_2˜LGC_7 includes six input ends and one output, and inverters are installed in front of a portion of the input ends, for inverting corresponding signals, so as to correctly determine an order of corresponding numerics. Since the median of the numerics VL_1˜VL_7 must be greater than (or equal to) three of the numeris and less than three of the numerics, the logic units LGC_2˜LGC_7 output “1” when three corresponding input signals are “1”, and output “0” other else, to determine whether a corresponding numeric is the median VL_med. The multiplexer module 104 includes multiplexers MUX2˜MUX7, each including input ends I1, I2, for choosing to output a signal received at the input end I2 when the corresponding logic unit outputs “1”. For example, if the logic unit LGC_2 outputs “1”, the multiplexer MUX_2 determines to output a signal received at the input end I2 thereof.

Therefore, by means of the comparison module 100, the logic module 102 and the multiplexer module 104, the median filter 10 can determine the median VL_med of the numerics VL_1˜VL_7. However, as illustrated in FIG. 1, an amount of the required comparators CMP in the comparison module 100 increases with a sampling number thereof. If the sampling number is n, the amount NM of the comparators CMP is:

$$NM = \frac{( n - 1 + 1 ) ( n - 1 )}{2} = \frac{{n}^{2}}{2} - \frac{n}{2}$$

In the upper equation, the amount NM is directly proportional to a square of the sampling number n. In addition to cost concerns, another obvious shortage of the median filter 10 is poor expansibility. In other words, the median filter 10 can only be utilized for determining the median, and nothing else, such as the third greatest numeric or the third least numeric.

Therefore, for the median filter of the prior art, overcoming cost issues and enhancing expansibility would be necessary.

### SUMMARY OF THE INVENTION

It is therefore a primary objective of the claimed invention to provide a numeric decision device.

The present invention discloses a numeric decision device for determining a numeric of a specific order in a plurality of numerics. The numeric decision device comprises a plurality of reception ends for receiving the plurality of numerics, a plurality of multiplexer modules, each coupled to one of the plurality of reception ends for outputting a numeric received by the reception end or a default value according to one of a plurality of decoding results, a comparison module coupled to the plurality of multiplexer modules for comparing a plurality of output signals of the plurality of multiplexer modules to generate a plurality of comparison results, and determining an extreme value of the plurality of output signals, a decoding module coupled between the comparison module and the plurality of multiplexer modules for generating the plurality of decoding results according to the plurality of comparison results, a driving module, coupled to the plurality of multiplexer modules, the comparison module and the decoding module for controlling the plurality of multiplexer modules, the comparison module and the decoding module to operate for default times corresponding to the specific order, and an output unit coupled to the comparison module and the driving module for outputting the extreme value after the comparison module operates for the default times to determine the numeric of the specific order.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a median filter of the prior art.

FIG. 2 is a schematic diagram of a numeric decision device according to an embodiment of the present invention.

FIG. 3A is a schematic diagram of an embodiment of a multiplexer module shown in FIG. 2.

FIG. 3B is a schematic diagram of an embodiment of a multiplexer module shown in FIG. 2.

FIG. 3C is a schematic diagram of an embodiment of a multiplexer module shown in FIG. 2.

FIG. 4A is a schematic diagram of an embodiment of a comparison module shown in FIG. 2.

FIG. 4B is a schematic diagram of a comparison unit shown in FIG. 4A.

FIG. 4C is a schematic diagram of an embodiment of a comparison module of seven samples.

FIG. 5A is a schematic diagram of an embodiment of a decoding module shown in FIG. 2.

FIG. 5B is a schematic diagram of an embodiment of a decoding module of seven samples.

### DETAILED DESCRIPTION

In light of numeric comparison, when comparing numerics in a descending sequence, the first numeric is the maximum numeric among all numerics, and the second numeric is the maximum numeric among all numerics except the first numeric. Accordingly, the m-th numeric is the maximum numeric among all numerics except the first to (m-1)-th numerics. That is, to determine the m-th numeric, repeating a maximum value determination process is feasible. More specifically, the maximum value determination process includes:

(1) determining the maximum numeric (the first order) among all numerics,

(2) replacing the maximum numeric with a minimum numeric,

(3) determining another maximum numeric (the second order) among all numerics, and

(4) repeating (1)-(3) until the numeric of the m-th order is determined.

The maximum value determination process in the above is designed for the descending sequence. Certainly, a numeric of any order in an ascending sequence can be determined based upon the same concept.

As can be seen from the above, by repeating an extreme value determination process, a numeric of a specific order in a sequence can be acquired. Accordingly, any numeric with special meaning of order, such as the median, can be searched based upon this method. In such a situation, the present invention provides a numeric decision device for implementing the above method.

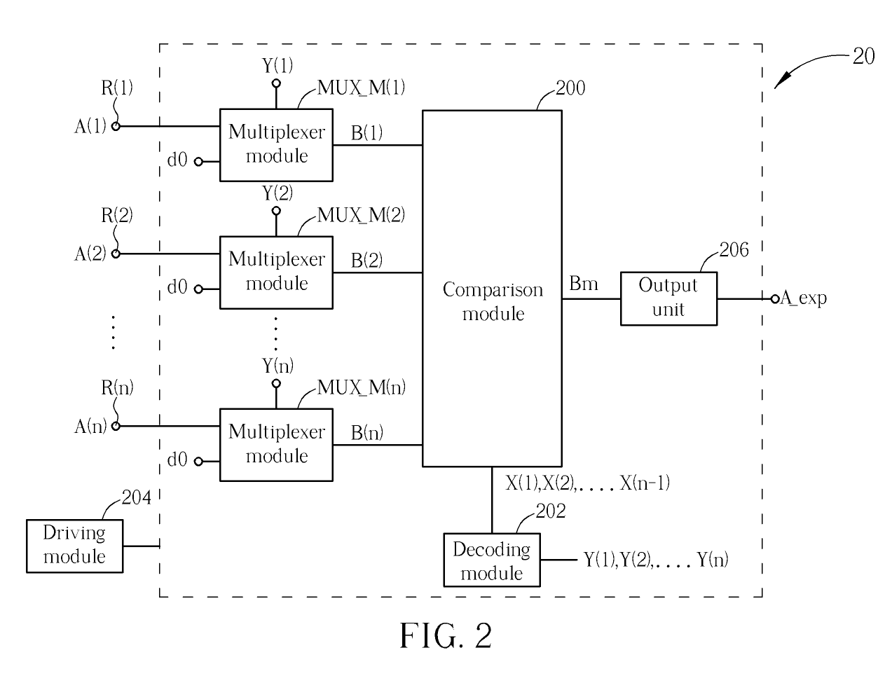

Please refer to FIG. 2, which is a schematic diagram of a numeric decision device 20 according to an embodiment of the present invention. The numeric decision device 20 is utilized for determining a numeric A_exp of a specific order in numerics A(1)˜A(n), and includes reception ends R(1)˜R(n), multiplexer modules MUX_M(1)˜MUX_M(n), a comparison module 200, a decoding module 202, a driving module 204 and an output unit 206. The driving module 204 controls operation times of each components based upon a desired order. First, the multiplexer modules MUX_M(1)˜MUX_M(n) receive the numerics A(1)˜A(n) numerics or a default value d0 according to decoding results Y(1)˜Y(n) outputted by the decoding module 202, to generate output signals B(1)˜B(n) to the comparison module 200. The comparison module 200 can compare the output signals B(1)˜B(n) to generate comparison results X(1)˜X(n−1), and determine an extreme value Bm of the output signals B(1)˜B(n). The decoding module 202 generates the decoding results Y(1)˜Y(n) to the multiplexer modules MUX_M(1)˜MUX_M(n) according to the comparison results X(1)˜X(n−1), wherein each of the decoding results Y(1)˜Y(n) is utilized for indicating whether the output signal of a corresponding multiplexer module is the extreme value Bm. If true, the multiplexer module replaces the original output signal with the default value d0 in a next operation cycle, as described in the following.

First, when initiated, a multiplexer module MUX_M(x), which is an embodiment of any of the multiplexer modules MUX_M(1)˜MUX_M(n), transfers the corresponding numeric A(x) to the comparison module 200, i.e. B(x)=A(x). If the output signal B(x) is the extreme value among the output signals B(1)˜B(n), the decoding module 202 determines that the output signal B(x) is the extreme value according to the comparison results X(1)˜X(n−1), and sets the corresponding decoding result Y(x) to be a specific value indicating that the numeric A(x) is the numeric of the first order among the numerics A(1)˜A(n). Next, during the next operation cycle, the multiplexer module MUX_M(x) can determine the numeric A(x) to be the extreme value of the numerics A(1)˜A(n) according to the decoding result Y(x), and transfer the default value d0 to the comparison module 200, i.e. B(x)=d0. In such a situation, since the output signal B(x) is set to be d0, the comparison module 200 can acquire the numeric of the second order. Accordingly, by repeating the extreme value decision process based upon the desired order, the desired numeric A_exp can be determined.

Note that, the default value d0 should be set based upon the tendency of the sequence and the desired order. Similarly, the extreme value (ex. Bm) should be set to be the maximum value or the minimum value accordingly. That is, if the numeric A_exp is the a-th numeric among the numerics A(1)˜A(n) in a descending order, the default value d0 should be set to be the minimum value of all possible values the numerics A(1)˜A(n) can be, and the extreme value Bm should be set to be the maximum value. Under such configuration, the desired result can be determined after “a” operation cycles. On the contrary, if the numeric A_exp is the b-th numeric among the numerics A(1)˜A(n) in an ascending order, the default value d0 should be set to be the maximum value of all possible values the numerics A(1)˜A(n) can be, and the extreme value Bm should be set to be the minimum value. Under such configuration, the desired result can be determined after “b” operation cycles.

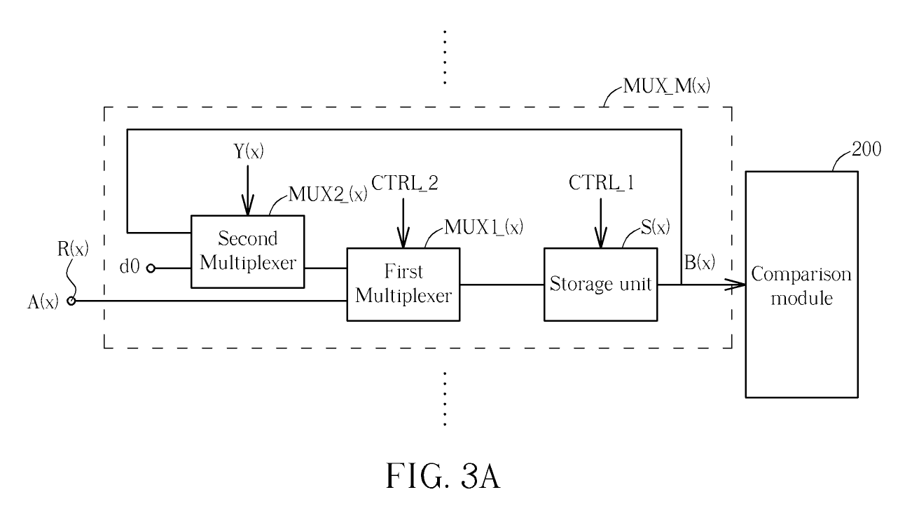

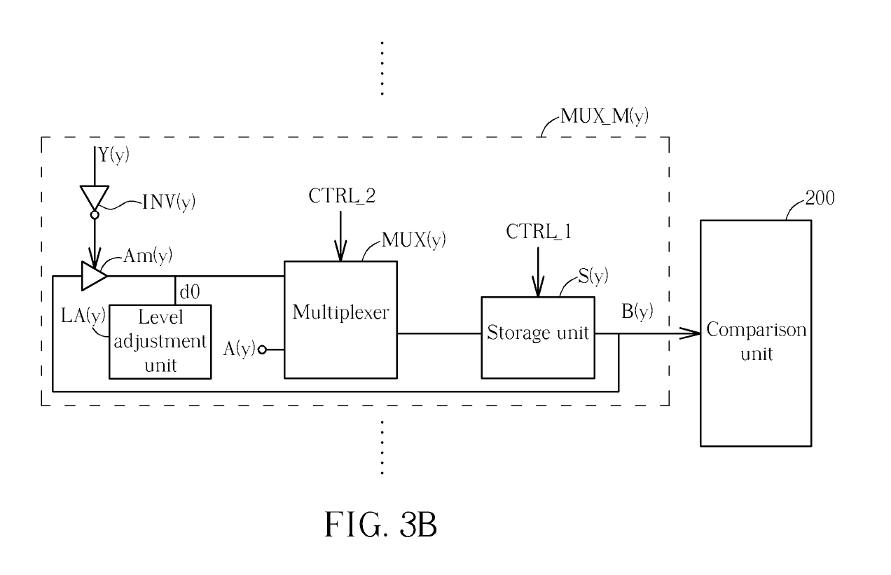

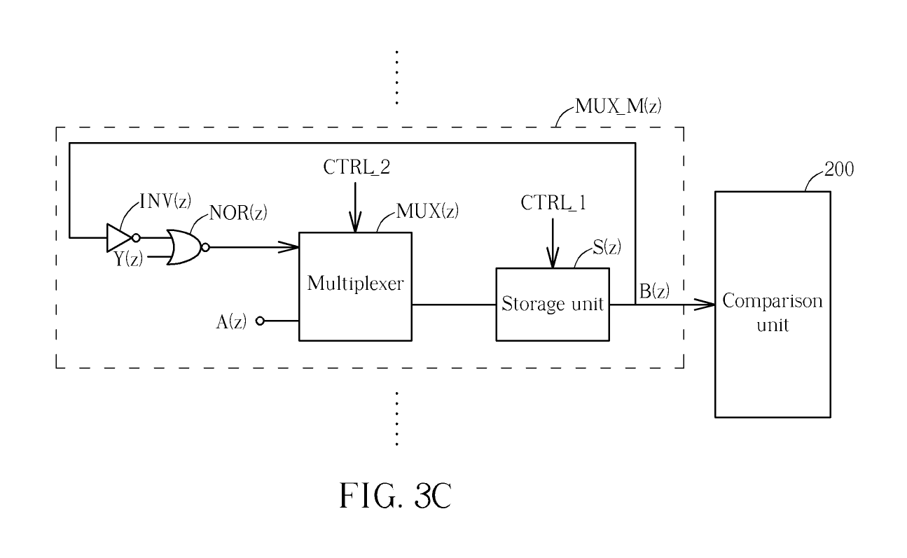

The numeric decision device 20 shown in FIG. 2 is merely one embodiment of the present invention, and can be accordingly modified and varied by those skilled in the art to acquire a numeric of a specific order by repeating the extreme value decision process. For example, please refer to FIG. 3A, which is a schematic diagram of an embodiment of the multiplexer module MUX_M(x) shown in FIG. 2. As illustrated in FIG. 3A, the multiplexer module MUX_M(x) includes a storage unit S(x), a first multiplexer MUX1_(x) and a second multiplexer MUX2_(x). The storage unit S(x) is utilized for storing a first multiplexing output signal outputted by the first multiplexer MUX1_(x), and outputting the first multiplexing output signal to the comparison module 200 and the second multiplexer MUX2_(x) according to a first control signal CTRL_1 outputted by the driving module 204. The first multiplexer MUX1_(x) can choose to output the numeric A(x) or a second multiplexing output signal outputted by the second multiplexer MUX2_(x) to the storage unit S(x) according to a second control signal CTRL_2 outputted by the driving module 204. The second multiplexer MUX2_(x) chooses to output signals stored in the storage unit S(x) or the default value d0 to the first multiplexer MUX1_(x) according to the decoding result Y(x). The first control signal CTRL_1 is related to the circulation of the numeric decision device 20, and is utilized for controlling the storage unit S(x) to timely output the stored data. The second control signal CTRL_2 is utilized for indicating whether the numeric decision device 20 operates in an initial mode to correctly generate the first multiplexing output signal to the storage unit S(x). In short, when the numeric decision device 20 operates in the initial mode, the second control signal CTRL_2 is equal to a specific value (e.g. 1), such that the first multiplexer MUX1_(x) chooses to output the numeric A(x) to the storage unit S(x). Inversely, when the numeric decision device 20 does not operate in the initial mode, the second multiplexer MUX2_(x) chooses to output the output signal B(x) of the previous operation cycle or the default value d0 to the first multiplexer MUX1_(x) according to the decoding result Y(x). In such a situation, the second control signal CTRL_2 is equal to another specific value (e.g. 0), such that the first multiplexer MUX1_(x) chooses to output the output signal of the second multiplexer MUX2_(x) to the storage unit S(x).

In short, via the multiplexer module MUX_M(x) shown in FIG. 3A, if the order of the numeric A(x) is superior than the order of the numeric A_exp, the output signal B(x) would be replaced by the default value D0 after the numeric A_exp is determined. Inversely, if the order of the numeric A(x) is inferior than the order of the numeric A_exp, the output signal B(x) is still equal to the numeric A(x). Since the multiplexer modules MUX_M(1)˜MUX_M(n) replace the extreme value of a previous operation cycle with the default value d0, the numeric A_exp can be determined after adequate operation cycles based upon the desired order.

Alternatively, please refer to FIG. 3B, which is a schematic diagram of a multiplexer module MUX_M(y) of the multiplexer modules MUX_M(1)˜MUX_M(n) shown in FIG. 2 in accordance with an embodiment of the present invention. In FIG. 3B, the multiplexer module MUX_M(y) includes a storage unit S(y), a multiplexer MUX(y), an amplifier Am(y), an inverter INV(y) and a level adjustment unit LA(y). The inverter INV(y) is coupled to the decoding module 202, and is utilized for generating an inverted result of the decoding result Y(y) to the amplifier Am(y). The amplifier Am(y), preferably a unit-gain amplifier, can control whether to output the output signal B(y) to the multiplexer MUX(y) according to the inverted result of the decoding result Y(y). The level adjustment unit LA(y) is utilized for adjusting (by pulling down or putting up) a level of a corresponding signal when the amplifier Am(y) stops operating, to output the default value d0 to the multiplexer MUX(y), so as to prevent an output end of the amplifier Am(y) from floating. The multiplexer MUX(y) can choose to output the numeric A(y) or the output signal of the amplifier Am(y) and the level adjustment unit LA(y) to the storage unit S(y) according to the second control signal CTRL_2 outputted by the driving module 204. The storage unit S(y) is utilized for storing the multiplexing output signal outputted by the multiplexer MUX(y) and outputting the multiplexing output signal to the comparison module 200 and the amplifier Am(y). In short, when the numeric decision device 20 operates in the initial mode, the second control signal CTRL_2 is equal to a specific value (e.g. “1”), to enable the multiplexer MUX(y) to output the numeric A (y) to the storage unit S(y). Inversely, when the numeric decision device 20 does not operate in the initial mode, the second control signal CTRL_2 is equal to another specific value (e.g. “0”), to enable the multiplexer MUX(y) to output the output signal B(y) of the previous operation cycle to the storage unit S(y). In such a situation, if the output signal B(y) is the extreme value of the previous operation cycle, the amplifier Am(y) stops operating based upon the decoding result Y(y) at a next operation cycle, and outputs the result adjusted by the level adjustment unit LA(y), i.e. the default value d0.

Note that, in FIG. 3B, the level adjustment unit LA(y) should pull up or down the level of the corresponding signal based upon the tendency of the sequence and the desired order, i.e. setting the default value d0 according to the tendency of the sequence and the desired order. That is, if the numeric A_exp is the a-th numeric in the descending order including the numerics A(1)˜A(n), the default value d0 should be set as the minimum value among all possible values the numerics A(1)˜A(n) can be, i.e. the level adjustment unit LA(y) pulls down the level of the corresponding signal, and the extreme value Bm should be set to be the maximum value. Under such a configuration, the desired result can be acquired after “a” times of operation. Inversely, if the numeric A_exp is the b-th numeric in the ascending order including the numerics A(1)˜A(n), the default value d0 should be set as the maximum value among all possible values the numerics A(1)˜A(n) can be, i.e. the level adjustment unit LA(y) puts up the level of the corresponding signal, and the extreme value Bm should be set to be the minimum value. Under such a configuration, the desired result can be acquired after “b” times of operation.

In short, by the multiplexer module MUX_M(y) shown in FIG. 3B, if the order of the numeric A(y) is superior than the order of the numeric A_exp, the output signal B(y) is replaced with the default value d0 before the numeric A_exp is determined. Inversely, if the order of the numeric A(y) is inferior than the order of the numeric A_exp, the output signal B(y) is still equal to the numeric A(y). Since the multiplexer modules MUX_M(1)˜MUX_M(n) replace the extreme value of a previous operation cycle with the default value d0, the numeric A_exp can be determined after adequate operation cycles based upon the desired order.

Certainly, the default value d0 can be generated in a way other than the embodiments shown in FIG. 3A and FIG. 3B, or generated by logic operations. For example, please refer to FIG. 3C, which is a schematic diagram of a multiplexer module MUX_M(z) of the multiplexer modules MUX_M(1)˜MUX_M(n) shown in FIG. 2 in accordance with an embodiment of the present invention. In FIG. 3C, the multiplexer module MUX_M(z) includes a storage unit S(z), a multiplexer MUX(z), an inverter INV(z) and a NOR-gate NOR (z). Operations of the storage unit S(z) and the multiplexer MUX(z) are similar to the storage unit S(y) and the multiplexer MUX(y) shown in FIG. 3B, and not further narrated herein. The inverter INV(Y) is coupled to the storage unit S(z), and is utilized for generating an inverted result of an output signal B(z) to the NOR-gate NOR(z). The NOR-gate NOR(z) is utilized for performing a NOR operation on the inverted result of the output signal B(z) and the decoding result Y(z), and outputting a NOR gate computation result to the multiplexer MUX(z). As known by those skilled in the art, in a NOR operation, a NOR computation result is “0” as long as any of input signals is “1”. Therefore, if the output signal B(z) is the extreme value of the previous operation cycle, the NOR gate computation result has to be equal to “0”, i .e. the default value d0.

Certainly, in FIG. 3C, the NOR-gate NOR(z) is merely one embodiment of the present invention, and can be modified and varied by those skilled in the art based upon the tendency of the sequence and the desired order.

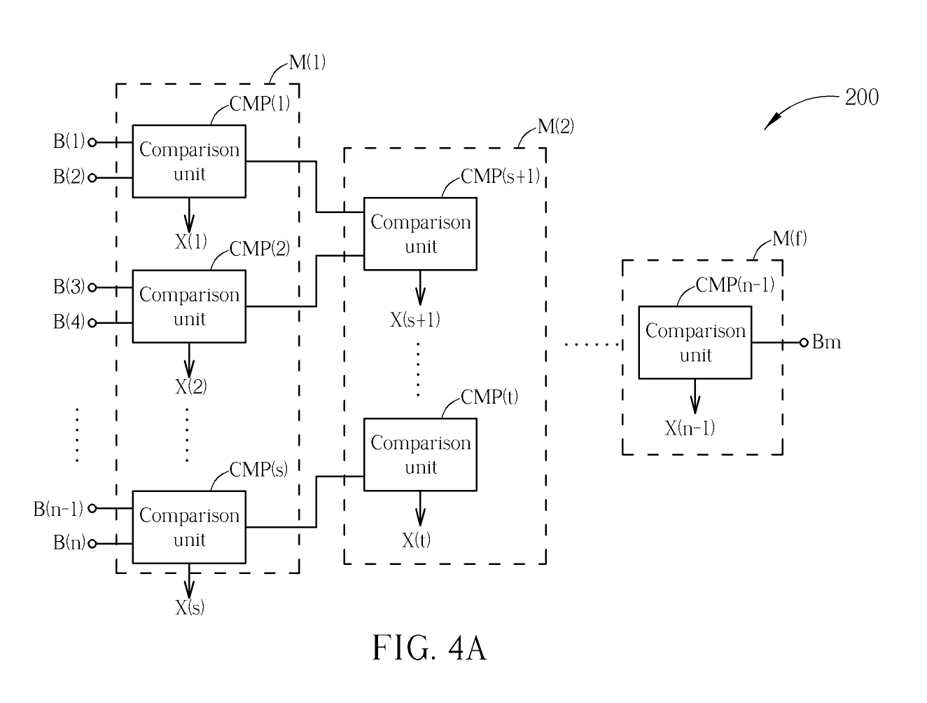

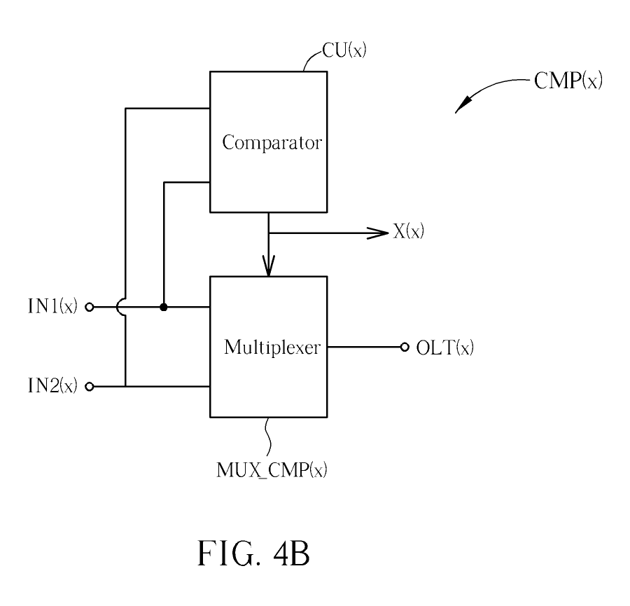

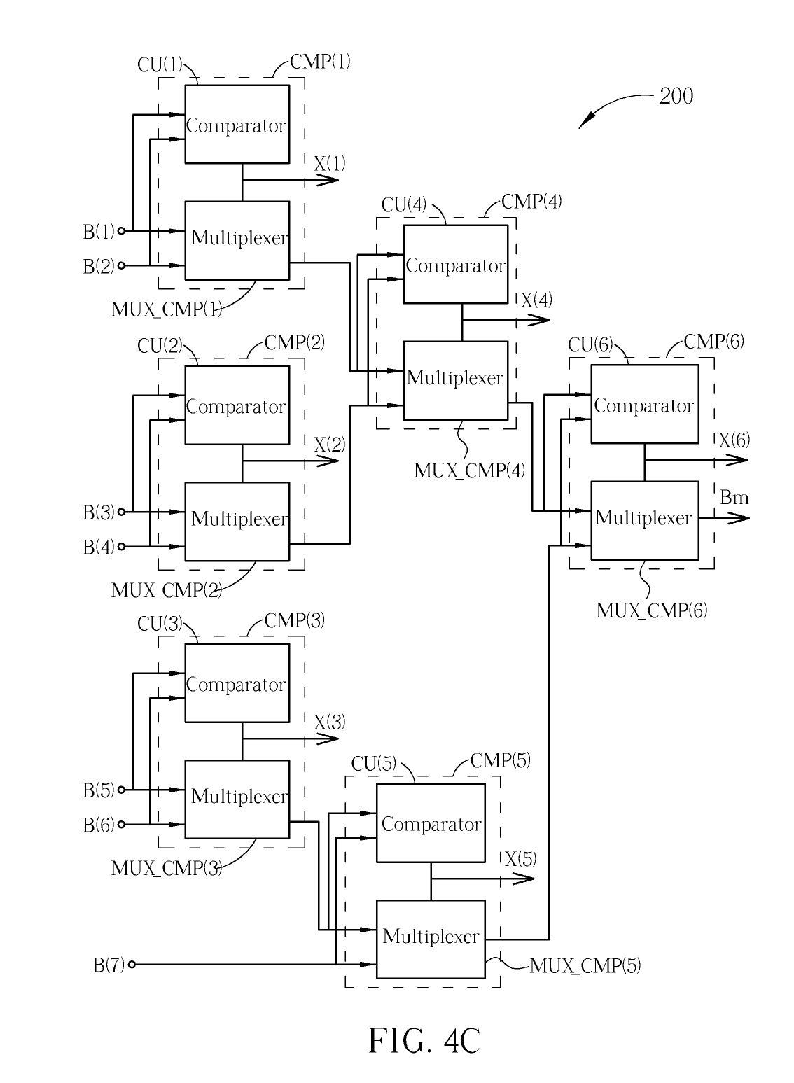

Moreover, please refer to FIG. 4A, which is a schematic diagram of the comparison module 200 shown in FIG. 2 according to an embodiment of the present invention. The comparison module 200 is composed of comparison units CMP(1)˜CMP(n−1), and can be further divided into “f” sub-module stages M(1)˜M(f). Please refer to FIG. 4B as well, which is a schematic diagram of any comparison unit CMP(x) shown in FIG. 4A. The comparison unit CMP(x) includes a comparator CU(x) and a multiplexer MUX_CMP(x). The comparison unit CMP(x) receives output signals at reception ends IN1(x), IN2(x), and outputs a comparison result X(x) to the decoding module 202 and the multiplexer MUX_CMP(x) after the comparator CU(x) finishes the comparison. Meanwhile, the multiplexer MUX_CMP(x) chooses to output the signal of the reception end IN1(x) or the signal of the reception end IN2(x) to a next sub-module stage via an output end OUT(x) according to the comparison result X(x). Note that, the comparison unit CMP(x) shown in FIG. 2B is a representative of the comparison units CMP(1)˜CMP(n−1) except for external connections and configuration thereof. For example, if the comparison unit CMP(x) is located within the sub-module stage M(1), the reception ends IN1(x), IN2(x) should be coupled to two of the multiplexer modules MUX_M (1)˜MUX_M(n), and the output end OUT(x) should be coupled to a comparison unit of a next sub-module stage. In addition, the amount “f” of the sub-module stages M(1)˜M(f) depends on the amount “n” of the numerics A(1)˜A(n). That is, if a two-input comparison method is used to determine the maximum value among “n” numerics, “f” should be decided according to the following equations:

2^{f}≧n

[symbol]

log 2^{f}≧log n

[symbol]

f≧log₂ n

Note that, FIG. 4A and FIG. 4B illustrate two embodiments of the comparison module 200, and can be modified and varied by those skilled in the art, especially for the input ends and the output end of the comparison unit CMP(x), whose connecting method should be designed based upon the amount “n” of the numerics A(1)˜A(n). For example, when n=7, the comparison module 200 implemented in accordance with FIG. 4A and FIG. 4B is illustrated in FIG. 4C. In addition, the comparison logic of any comparison unit CMP(x) should be set based upon the tendency of the sequence and the desired order. For example, if the numeric A_exp is a numeric of a specific order in the descending sequence including the numerics A(1)˜A(n), the comparison result X(1) of the comparison unit CMP(1) indicates whether the output signal B(1) is greater than the output signal B(2). Inversely, if the numeric A_exp is a numeric of a specific order in the ascending sequence including the numerics A(1)˜A(n), the comparison result X(1) of the comparison unit CMP(1) indicates whether the output signal B(2) is greater than the output signal B(1).

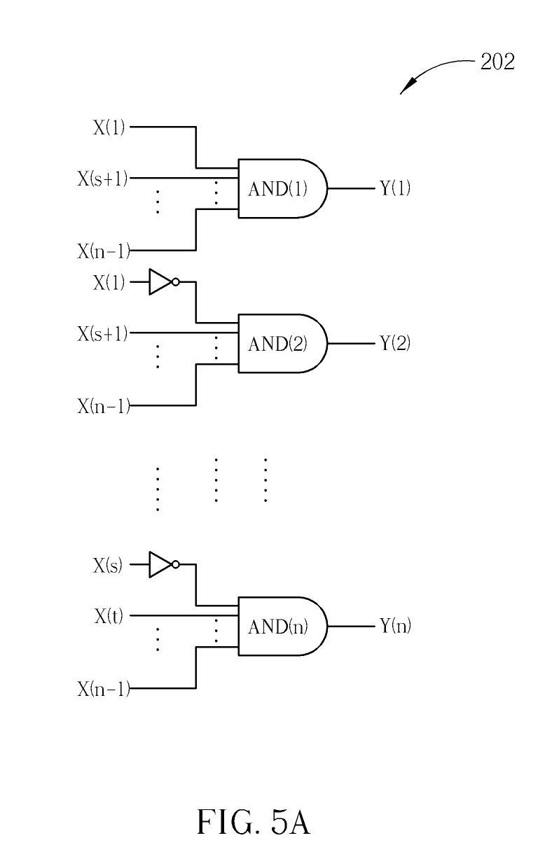

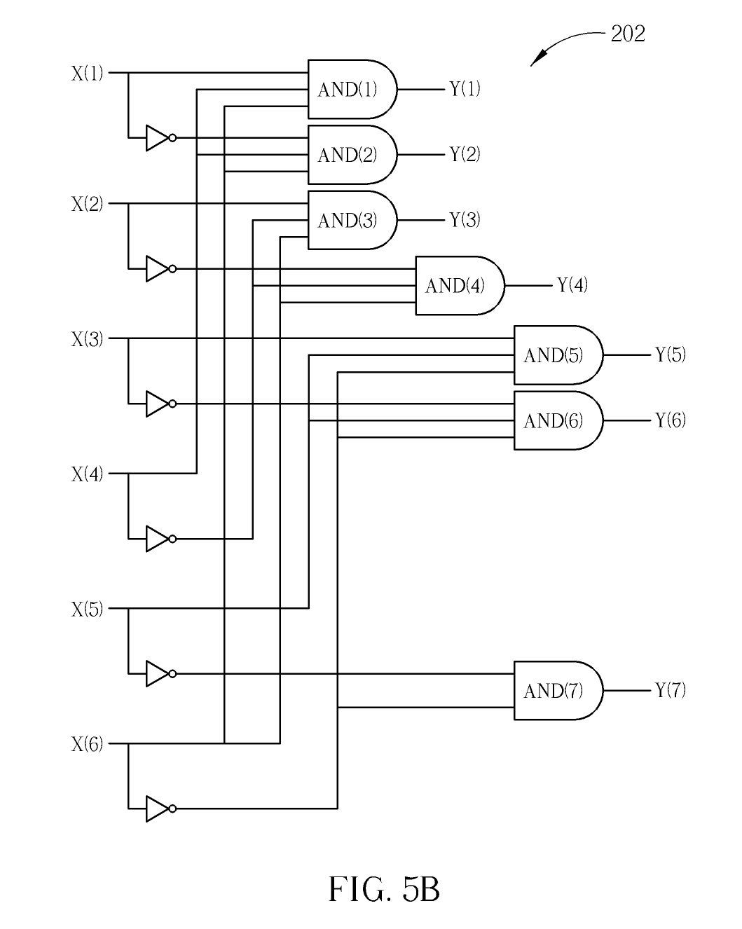

On the other hand, the decoding module 202 should be well designed to match the design of the comparison module 200. For example, please refer to FIG. 5A, which is a schematic diagram of an embodiment of the decoding module 202. In FIG. 5A, the decoding module 202 is composed of AND gates AND(1)˜AND(n) and inverters coupled in front of a portion of the AND gates AND (1)˜AND (n). In detail, each AND gate is corresponding to a numeric, and is utilized for determining whether the numeric is the maximum value of an operation cycle. As illustrated in FIG. 4A and FIG. 5A, for example, input signals of the AND gate AND(1) are comparison results X(1), X(s+1), . . . , X(n−1), i.e. the comparison results are related to the output signal B(1). In the same operation cycle, the output signal B(1) is the maximum value as long as all the comparison results related to the output signal are “1”. In such a situation, the corresponding decoding result Y(1) of the AND-gate AND(1) is “1” as well, and the multiplexer module MUX_M(1) can accordingly determine (during a next operation cycle) the numeric A(1) to be the maximum value of the operation cycle. In addition, for the AND gate AND(2), the comparison result X(1) has to be inverted since the comparison result X(1) indicates whether the output signal B(1) is greater than the output signal B(2), and this inversion operation is well known to those skilled in the art.

In FIG. 5A, the decoding module 202 is implemented by the AND gates. In practice, those skilled in the art can implement the decoding module 202 by other logic units, which is acceptable as long as the extreme value can be determined according to all comparison results related to a corresponding output signal. Meanwhile, the connecting method of input and output ends of the AND-gates AND (1)˜AND (n) should be decided in accordance with the decoding module 202. For example, if n=7, cooperated with the comparison module 200 shown in FIG. 4C, the decoding module 202 can be implemented as illustrated in FIG. 5B.

Using the multiplexer modules MUX_M(1)˜MUX_M(n), the comparison module 200 and the decoding module 202, the present invention can determine the extreme value Bm during each operation cycle. Preferably, the output unit 206 can temporarily store the extreme value Bm during each operation cycle. As a result, the driving module 204 can timely control the output unit 206 to output the extreme value Bm (the desired numeric A_exp) according to the desired order. That is, the driving module 204 controls operation times of the multiplexer modules MUX_M(1)˜MUX_M(n), the comparison module 200 and the decoding module 202 according to the desired order. Once the default operation times are achieved, the driving module 204 controls the output unit 206 to output the extreme value Bm, i.e. the desired numeric A_exp.

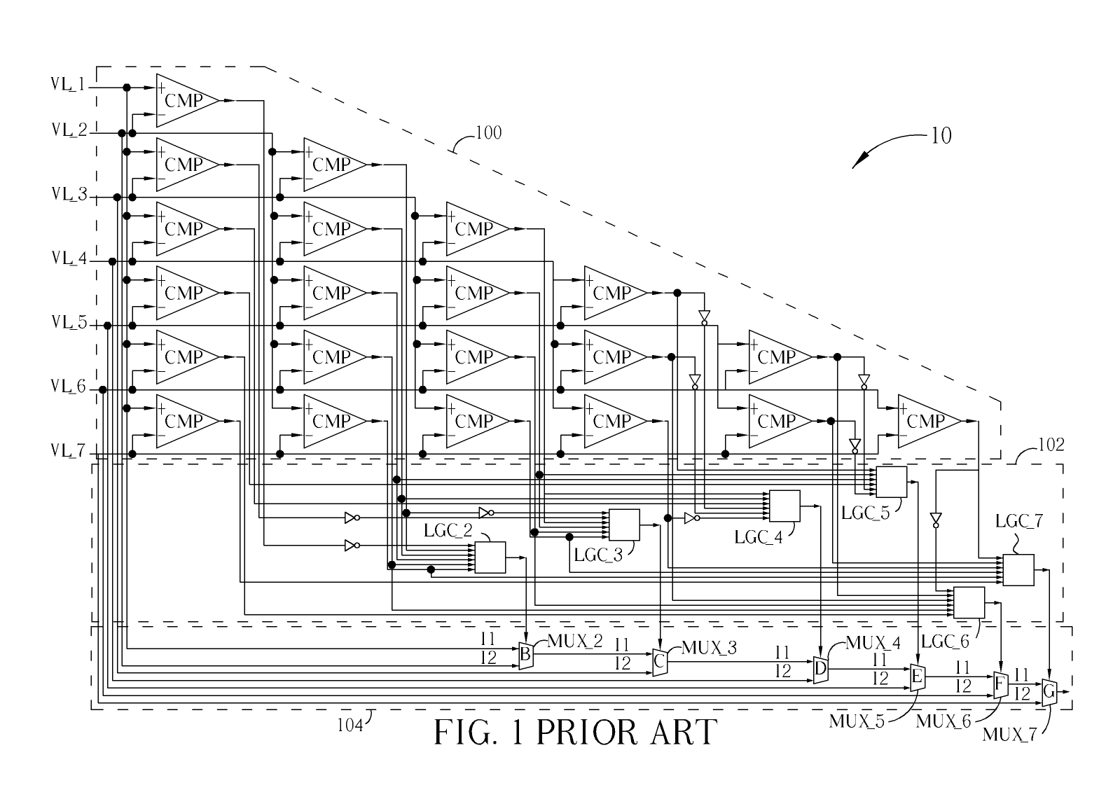

By repeating the extreme value determination process, the numeric decision device 20 can determine a numeric of any specific order. Furthermore, as illustrated in FIG. 4A, the amount of the comparators required in the numeric decision device 20 is directly proportional to “n” to the power of 1, capable of reducing costs in comparison with the prior shown in FIG. 1. For example, in case of seven samples, the amount of the required comparators is directly proportional to the square of “n” in the prior art, and is directly proportional to “n” to the power of 1 in the present invention. Obviously, for acquiring the median, the present invention can effectively reduce the cost, and furthermore, can be applied for determining any numeric with specific meaning of order more than the median.

To sum up, by repeating the extreme value determination process, the present invention can determine any numeric with specific meaning of order under low implementation costs.

Those skilled in the art will readily observe that numerous modifications and alterations of the device and method may be made while retaining the teachings of the invention.

What is claimed is:

1. A numeric decision device, for determining a numeric of a specific order in a plurality of numerics, the numeric decision device comprising:
a plurality of reception ends, for receiving the plurality of numerics;
a plurality of multiplexer modules, each coupled to one of the plurality of reception ends, for outputting a numeric received by the reception end or a default value according to one of a plurality of decoding results;
a comparison module, coupled to the plurality of multiplexer modules, for comparing a plurality of output signals of the plurality of multiplexer modules to generate a plurality of comparison results, and determining an extreme value of the plurality of output signals;
a decoding module, coupled between the comparison module and the plurality of multiplexer modules, for generating the plurality of decoding results according to the plurality of comparison results;
a driving module, coupled to the plurality of multiplexer modules, the comparison module and the decoding module, for controlling the plurality of multiplexer modules, the comparison module and the decoding module to operate for default times corresponding to the specific order; and
an output unit, coupled to the comparison module and the driving module, for outputting the extreme value after the comparison module operates for the default times to determine the numeric of the specific order.

2. The numeric decision device of claim 1, wherein each of the plurality of multiplexer modules outputs the default value when a corresponding decoding result indicates that the output signal of the multiplexer module is the extreme value of the plurality of output signals.

3. The numeric decision device of claim 1, wherein each of the plurality of multiplexer modules comprises:
a storage unit, for storing a first multiplexing output signal and outputting the first multiplexing output signal to the comparison module according to a first control signal;
a first multiplexer, for receiving one of the plurality of numerics and a second multiplexing output signal, and choosing to output the numeric or the second multiplexing output signal according to a second control signal, to output the first multiplexing output signal to the storage unit; and
a second multiplexer, for receiving the first multiplexing output signal outputted by the storage unit and the default value, and choosing to output the first multiplexing output signal or the default value according to one of the plurality of decoding results, to output the second multiplexing output signal to the first multiplexer.

4. The numeric decision device of claim 3, wherein the driving module is further utilized for outputting the first control signal and the second control signal to control each multiplexer module to operate for the default times.

5. The numeric decision device of claim 3, wherein the first multiplexer chooses to output the numeric when the second control signal of the driving module indicates that the numeric decision device operates in an initial mode, in order to output the first multiplexing output signal to the storage device.

6. The numeric decision device of claim 3, wherein the first multiplexer chooses to output the second multiplexing output signal when the second control signal of the driving module indicates that the numeric decision device does not operate in an initial mode, in order to output the first multiplexing output signal to the storage device.

7. The numeric decision device of claim 3, wherein the second multiplexer chooses to output the default value when the decoding result indicates that the first multiplexing output signal outputted from the storage unit to the comparison module is the extreme value of the plurality of output signals, to output the second multiplexing output signal to the first multiplexer.

8. The numeric decision device of claim 3, wherein the second multiplexer chooses to output the first multiplexing output signal when the decoding result indicates that the first multiplexing output signal outputted from the storage unit to the comparison module is not the extreme value of the plurality of output signals, to output the second multiplexing output signal to the first multiplexer.

9. The numeric decision device of claim 1, wherein each of the plurality of multiplexer modules comprises:
an amplifier, for outputting a multiplexing output signal according to an inverted result of one of the plurality of decoding results to generate an amplification result;
a level adjustment unit, for adjusting a level of the amplification result;
a storage unit, for storing the multiplexing output signal and outputting the multiplexing output signal to the comparison module and the amplifier according to the first control signal; and
a multiplier, for receiving one of the plurality of numerics and the amplification result, and choosing to output the numeric or the amplification result according to a second control signal to output the multiplexing output signal to the storage unit.

10. The numeric decision device of claim 9, wherein the amplifier is a unit-gain amplifier.

11. The numeric decision device of claim 9, wherein the amplifier stops outputting the multiplexing output signal when the decoding result indicates that the multiplexing output signal outputted from the storage unit to the comparison module is the extreme value of the plurality of output signals to generate the amplification result.

12. The numeric decision device of claim 11, wherein the level adjustment unit decreases the level of the amplification result to the default value when the extreme value is a maximum value.

13. The numeric decision device of claim 11, wherein the level adjustment unit increases the level of the amplification result to the default value when the extreme value is a minimum value.

14. The numeric decision device of claim 9, wherein the driving module is further utilized for outputting the first control signal and the second control signal to control each of the multiplexer modules to operate for the default times.

15. The numeric decision device of claim 9, wherein the multiplier chooses to output the numeric when the second control signal of the driving module indicates that the numeric decision device operates in an initial mode, in order to output the multiplexing output signal to the storage unit.

16. The numeric decision device of claim 9, wherein the multiplier chooses to output the amplification result when the second control signal of the driving module indicates that the numeric decision device does not operate in an initial mode, in order to output the multiplexing output signal to the storage unit.

17. The numeric decision device of claim 9 further comprising an inverter for generating the inverted result of the decoding result.

18. The numeric decision device of claim 1, wherein each of the plurality of multiplexer modules comprises:
a storage unit, for storing a multiplexing output signal and outputting the multiplexing output signal to the comparison module according to a first control signal;
a multiplier, for receiving one of the plurality of numerics and a NOR-gate computation result, and choosing to output the numeric or the NOR gate computation result according to a second control signal to output the multiplexing output signal to the storage unit;
an inverter, for generating an inverted result of the multiplexing output signal; and
a NOR gate, for performing a NOR operation on the multiplexing output signal and one of the plurality of decoding results to generate the NOR computation result to the multiplexer.

19. The numeric decision device of claim 18, wherein the driving module is further utilized for outputting the first control signal and the second control signal to control each of the multiplexer modules to operate for the default times.

20. The numeric decision device of claim 18, wherein the multiplexer chooses to output the numeric when the second control signal of the driving module indicates that the numeric decision device operates in an initial mode, in order to output the multiplexing output signal to the storage unit.

21. The numeric decision device of claim 18, wherein the multiplexer chooses to output the NOR gate computation result when the second control signal of the driving module indicates that the numeric decision device does not operate in an initial mode, in order to output the multiplexing output signal to the storage unit.

22. The numeric decision device of claim 1, wherein the comparison module comprises a plurality of sub-module stages, connected in series, each comprising at least one comparison unit, for comparing two of output signals of a former sub-module stage, to output a comparison result.

23. The numeric decision device of claim 22, wherein the first one of the plurality of sub-module stages is coupled to the plurality of multiplexer modules, and the last one is coupled to the output unit for outputting the extreme value of the plurality of output signals of the plurality of the multiplexer modules.

24. The numeric decision device of claim 22, wherein one of the at least one comparison unit comprises:
a comparator, for comparing a first output signal and a second output signal outputted from the former sub-module stage to output a comparison result; and
a multiplexer, for choosing to output the first output signal or the second output signal to a next sub-module stage according to the comparison result.

25. The numeric decision device of claim 1, wherein the decoding module comprises a plurality of logic units, respectively corresponding to the plurality of numerics, each utilized for generating a decoding result corresponding to a numeric according to one of the plurality of comparison results corresponding to the numeric, to indicate whether the numeric is the extreme value of the plurality of numerics.

26. The numeric decision device of claim 1, wherein the specific order is a rank of one of the plurality of numerics in a descending order.

27. The numeric decision device of claim 26, wherein the extreme value is a maximum value, and an amount of the default times is equal to a value of the specific order.

28. The numeric decision device of claim 26, wherein the extreme value is a minimum value, and an amount of the default times is equal to a difference between an amount of the plurality of numerics and a value of the specific order.

29. The numeric decision device of claim 1, wherein the specific order is a rank of one of the plurality of numerics in an ascending order.

30. The numeric decision device of claim 29, wherein the extreme value is a minimum value, and an amount of the default times is equal to a value of the specific order.

31. The numeric decision device of claim 29, wherein the extreme value is a maximum value, and an amount of the default times is equal to a difference between an amount of the plurality of numerics and a value of the specific order.
